(19) United States
(12) Patent Application Publication
(10) Pub. No.: US 2011/0119921 A1
(43) Pub. Date: May 26, 2011

(54) Fabric Former

(76) Inventor: Antonio Lewis, Atlanta, GA (US)

(21) Appl. No.: 12/623,407

(22) Filed: Nov. 21, 2009

(51) Int. Cl. E04H 15/58; B23P 11/00; B21D 47/00

(52) U.S. Cl. 29/897.32; 29/451; 29/700

(57) ABSTRACT

An apparatus for making a reinforcement strip includes a former for receiving and folding a foldable material about a longitudinal fold line. A pocket former may be provided to make a pocket for receiving piping. A piping guide may be provided to provide piping to the pocket. A support strip guide may be used to provide a support strip to the pocket.

### TECHNICAL FIELD

The invention relates to apparatus and methods for folding material and preparing material for sewing, and more specifically, to formers and methods for making reinforcement strips, hems, piping, and the like, for awnings and similar products.

### BACKGROUND OF THE INVENTION

A covering material may be stretched over a frame to form an awning or other protective cover. For example, canvas or other covering material may be stretched over an arrangement of support members defining a frame, to form an awning. Likewise, a covering material may be pulled over support poles to form a tent.

A reinforcement strip may be added to the edges of a covering material to provide additional strength to receive strings or support members that are used to pull the cover material taut over the frame. A typical reinforcement strip may comprise an elongated strip of material that is folded, sewn together and provided with a plurality of grommets and/or a channel for receiving support strings or support members. The reinforcement strip may be attached to the covering material, typically at the edges of the covering material, for use in coupling the covering material to the frame. For example, a covering material having a reinforcement attached its edges may be draped over an awning frame, ropes inserted through grommets in the reinforcement strip, and the ropes pulled taut to stretch the material over the frame and form an awning.

A reinforcement strip should be of sufficient strength to withstand the tension resulting from the taut ropes as well as the additional forces that may be exerted on the installed awning material by high wings and/or precipitation. In an effort to provide a reinforcement strip of sufficient strength, high strength materials, such as canvas, may be used for the reinforcement strip and covering material. To further strengthen the reinforcement strip, a piping rope and/or a support strip may be added to an inner channel formed in the reinforcement strip. It is difficult, however, for a worker to quickly and accurately fold material to form a reinforcement strip and provide the piping and/or support material within the fold in an arrangement that is easily sewn into a reinforcement strip that is easily attached to a reinforcing material.

### SUMMARY OF THE INVENTION

In an example embodiment, an apparatus is configured to receive a length of foldable material and arrange the material into a folded arrangement that is easily sewed together to form a reinforcement strip. In an example embodiment, the apparatus may comprise a former configured to fold a length of material along a longitudinal fold line to form a folded pocket and provide piping to a fold of the folded material to produce a folded arrangement that is readily sewed by a standard sewing machine into a reinforcement strip. The apparatus may be adapted for removable attachment to a sewing machine.

In one example embodiment, the former may comprise a body adapted to fold a length of material about a longitudinal fold line, a pocket maker adapted to create a pocket in the folded material, and a piping guide adapted to guide piping within the pocket. The apparatus may also include a support strip guide configured to receive a support strip and provide it to the pocket of the reinforcement strip. The apparatus may have a feed end configured to receive a foldable material, such as an awning material, piping, and/or support strip material and an output end arranged to provide the resulting arrangement of folded material to the bed of a sewing machine.

In one example embodiment, the former body comprises: a mouth configured to receive a length of foldable material, the material having a leading edge and two side edges; a folding portion to fold the material as the material passes through the body; and an output end to output the folded material in a desired arrangement to a sewing machine.

In an example embodiment, the mouth may comprise opposing generally planar base walls adjoined by opposing curved sidewalls, the base walls and sidewalls together forming a mouth sleeve having an elongated oval cross section and an open end to receive a length of the material. In an example embodiment, the mouth is shaped so that a central portion of the material inserted into the mouth covers the base and the side edges of the material are adjacent the curved sidewalls.

The fold portion of the body may be adjacent the mouth and comprise a sleeve configured to receive material from the mouth, fold the material in a desired manner, and provide the folded material to an output end. In an example embodiment, the fold portion may include a center sleeve, and opposing side sleeves that guide portions of the material through the body into a desired folded arrangement. In an example embodiment, the center sleeve may be adjacent the mouth and adapted to receive a center portion of the material and the side sleeves adapted to receive the outer edges of the material extending through the mouth. The body may be shaped so that as the body extends downstream in the direction that the material is passed through the device (i.e., from the feed end toward the output end), the side sleeves increase in size to accept more of the material as the center sleeve decreases in size to thereby fold the material in a along a desired fold line.

The side sleeves may be angled, curved, or otherwise adapted to extend from the mouth toward an outlet at the output end of the body. In an example embodiment, the side sleeves include a major sleeve of a first size and a minor sleeve of a second size, the major sleeve being of a greater size than the minor sleeve. Furthermore, in an example embodiment the fold line is positioned off-center from the centerline of the body. Applicant has found that this arrangement allows for the folding of the material while decreasing the bunching of the material as the material moves through the apparatus. The different sized side sleeves and the off center outlet produce a folded material having a margin of material of the major sleeve that extends over the material from the minor sleeve. The particular fold and output material size may be adjusted for a particular application. For example, the sleeves may be arranged to provide other sized margins or no margins at all. The center sleeve and side sleeves may be arranged to converge at an outlet with the bottom of the center sleeve creating a fold line.

A tongue may also be provided at the receiving end of the mouth to assist in guiding the length of material into the mouth. In an example embodiment, the tongue comprises a generally planar tab angled from the mouth to provide a support surface for the material.

The apparatus may also include a pocket former. In an example embodiment, a member having a curved end is provided near the center sleeve so that the material is pushed outward about the member to form a pocket as the material moves downstream. In an example embodiment, the pocket former is aligned with the center sleeve to create a pocket along the fold line of sufficient size and shape to receive a piping rope.

The apparatus may also include a piping guide for providing piping to the material to form a reinforcement strip of increased strength. In an example embodiment, a piping guide is in the form of an open-ended tube mounted to the body at the mouth and the outlet. The tube may be sized to receive piping at a feed end and provide the piping at an outlet end, the outlet end of the tube located at the convergence of the body outlet. In an example embodiment, the tube's outlet is arranged to provide the piping within the pocket. In an example embodiment, the tubing may serve as both a pocket former and a piping guide.

The apparatus may also include a support strip guide configured to provide a support strip to the material. In an example embodiment, the support strip guide is in the form of a wire or bracket spaced from the mouth and shaped to form to allow a support strip to extend through the guide into the mouth. The guide allows a user to easily control the feed of the support strip into the material. The support strip guide may be positioned on the mouth so that when fed into the mouth the support strip travels down through a sidewall sleeve to be positioned within the fold at the outlet.

An access opening may also be provided in the body to allow a user to view and/or access the material within the body if desired. For example, when starting the reinforcement strip manufacturing process a user may use the access opening to push the material through the body to the outlet, such as by pushing the material with the finger, the end of a pair of scissors, or other device. The guide may be arranged however, so that once the material is fed to a sewing machine, so that the sewing machine can pulls the material through the body without assistance. The access opening also allows a user to determine whether there is bunching of the material or some other problem. In an example embodiment, the access opening may be provided in the opposing base wall and at the sidewall sleeves.

Attachment means may be provided for removably attaching the apparatus to a sewing machine so that the output from the former is provided at the sewing bed of the sewing machine. In one example embodiment, the attachment means comprises an attachment plate that may be provided that includes a slot for fastening the plate to the bed of a sewing machine. In another example embodiment, a compressible plate may be configured for insertion between a sewing machine frame and sewing machine bed.

In another example embodiment, the apparatus may further include a fabric feeder that is engageable with the former and adapted to receive an unfolded length of material, fold the unfolded material to form a folded material, and provide the folded material to the former. The former can be used in conjunction with or without the fabric feeder. In an example embodiment, the fabric feeder may comprise a body that is configured for folding a length of material along a longitudinal fold line and provide the folded material to the former.

### BRIEF DESCRIPTION OF THE DRAWINGS

FIG. 1 shows a former attached to a sewing machine to produce a reinforcement strip.

FIG. 2 shows a left side view of a former.

FIG. 3 shows a cross section of the former of FIG. 2 along cut line 3-3.

FIG. 4 shows a cross section of the former of FIG. 2 along cut line 4-4.

FIG. 5 shows a cross section of the former of FIG. 2 along cut line 5-5.

FIG. 6 shows a cross section of the former of FIG. 2 along cut line 6-6.

FIG. 7 shows a left side view of the former of FIG. 1.

FIG. 8 shows a right side view of the former of FIG. 1.

FIG. 9 shows a top side view of the former of FIG. 1.

FIG. 10 shows a length of material for use with a former.

FIG. 11 shows an example embodiment of a reinforcement strip forming apparatus including a folder.

FIG. 12 shows a cross section of the former of FIG. 2 along cut line 3-3 in which a folded material is fed into the former.

FIG. 13 shows a cross section of the former of FIG. 2 along cut line 3-3 in which a folded material is fed into the former.

FIG. 14 shows a cross section of the former of FIG. 2 along cut line 3-3 in which a folded material is fed into the former.

FIG. 15 shows a cross section of the former of FIG. 2 along cut line 3-3 in which a folded material is fed into the former.

### DETAILED DESCRIPTION

As required, exemplary embodiments of the present invention are disclosed herein. These embodiments are meant to be examples of various ways of implementing the invention and it will be understood that the invention may be embodied in alternative forms. The figures are not to scale and some features may be exaggerated or minimized to show details of particular elements, while related elements may have been eliminated to prevent obscuring novel aspects. Therefore, specific structural and functional details disclosed herein are not to be interpreted as limiting, but merely as a basis for the claims and as a representative basis for teaching one skilled in the art to variously employ the present invention.

For discussion purposes, an apparatus for making a reinforcement strip may be discussed with reference to upstream and downstream, left and right, and other directional terms. These terms are not meant to be limiting but merely to assist one of skill in the art in the orientation of the drawings and no such limitations should be incorporated into the claims. The apparatus will be discussed generally as the material moves in a generally longitudinal direction into a mouth of a former, through the body of the former, and out an output end of the former to the bed of a sewing machine. The former may have a tongue extending from the open mouth to guide material into the mouth.

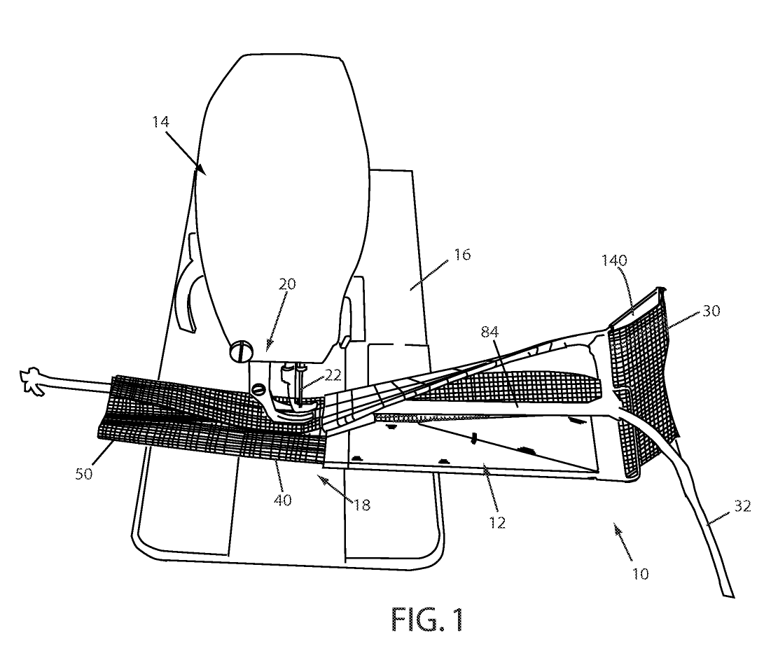

Turning to the figures, wherein like reference numbers represent like features throughout the views, FIG. 1 shows an example embodiment of apparatus 10 for making a reinforcement strip, the apparatus 10 may comprise a former 12 mounted to a conventional sewing machine 14 of the type having a base 16, a sewing bed 18 and a sewing head 20 having a reciprocating sewing needle 22. The former 12 is configured to receive a length of foldable material 30 and piping 32 and arranges the foldable material 30 and piping 32 into an arrangement 40 for sewing by a sewing machine 14 into a reinforcement strip 50.

The former 12 may be made of any suitable material. In an example embodiment, the former 12 is made of metal, such as stainless steel. Detents or recesses may be provided on the surface of the former to assist in creating air pockets to create an air flow between the former 12 and the material 30 to prevent sticking or bunching of the material 30 and help the material 30 move through the former 12. Additional assistance means could also be provided such as wheels, or the like.

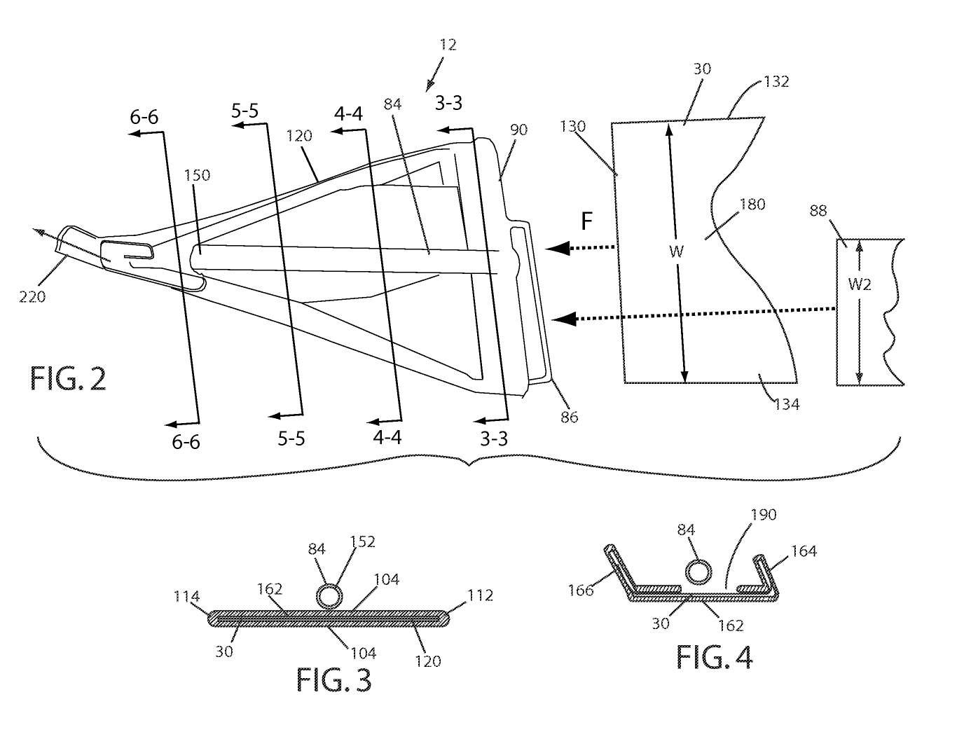

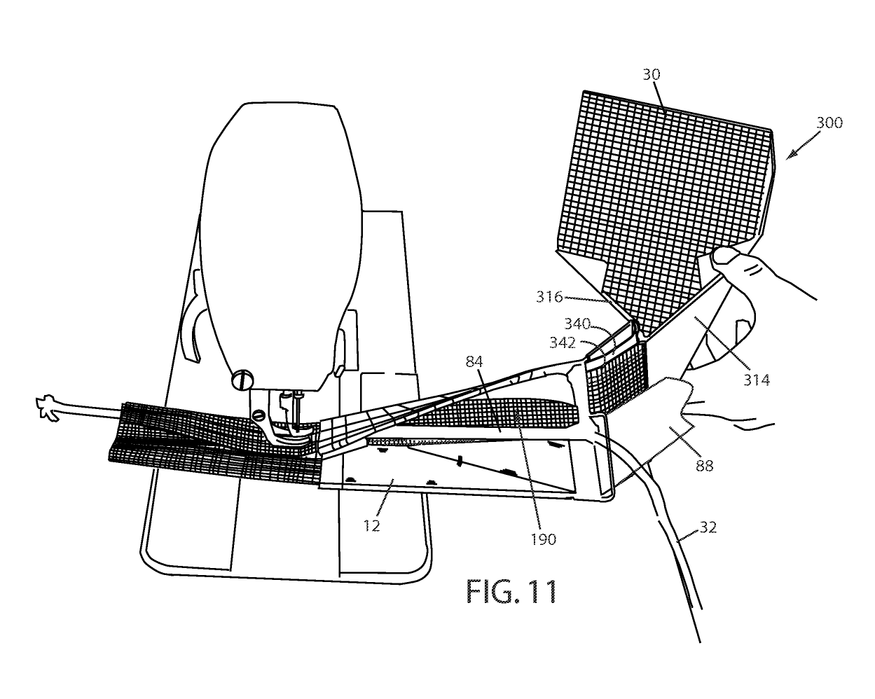

As shown in an example embodiment in FIG. 2, the former 12 may include a body 60 adapted to receive and fold a length of material 30 and arrange the material 30 into a folded arrangement 40 ready for sewing into a reinforcement strip 50. The former may also comprise, a pocket former 80 to create a pocket in the material 30, a piping guide 84 to guide piping within the pocket, and a support strip guide 86 to guide a support strip 88 (FIG. 11) into the pocket. At a first end of the body is a mouth 90 configured to receive a length of foldable material 30. As seen in FIG. 3, the mouth 90 may have an elongated oval shape comprising an upper base wall 102 and a lower basewall 104 and curved ends 112, 114 that together form a receiving sleeve 120 for the material 30.

As shown in FIG. 2, a material 30 may have a leading edge 130, side edges 132, 134, and a width w may be inserted into the mouth 90. The material 30 may be any foldable material, such as by way of example and not limitation, a fabric or canvas. In an example embodiment, a strip of canvas may be used in order to manufacture a reinforcement strip 50 for use with coupling with a covering material in forming an awning. The leading edge 130 of the material 30 may be inserted into the mouth 90. To assist the feed of the material into the mouth 90, a tongue 140 (FIG. 1) may be provided, such as an angled plate which provides a support surface for the material and leads to the mouth 90.

As shown in cross section in FIG. 3, in an example embodiment the material 30 may extend roughly the width of the sleeve 120 so that the side edges 132, 134 are proximate the curved sidewalls 112, 114 without bunching of the material 30. As also shown in FIG. 2, a piping guide 84 may also be provided. In an example embodiment, the piping guide 84 comprises an elongated tube 150 of round cross section having a receiving end 152 mounted atop the mouth 90. The piping guide 84 is configured to receive piping, such as a string or a rope, and guide the piping into a pocket formed in the material 30 as explained in more detail below.

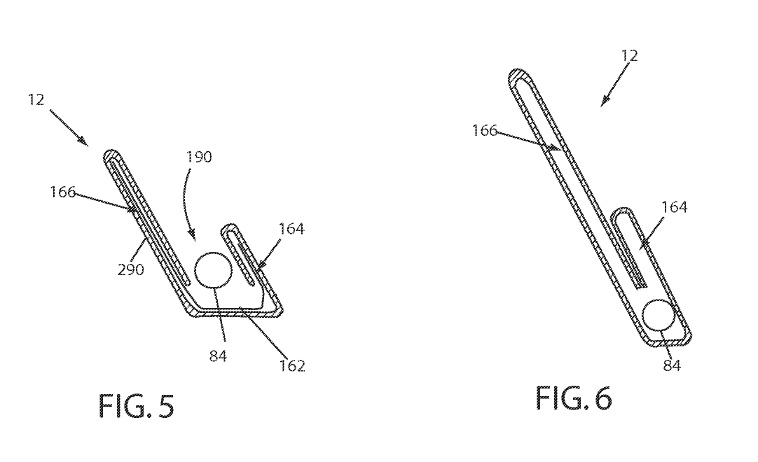

The body 60 may be adjacent the mouth 90 and the sleeve 120 configured to receive material 30 that moves through the mouth 90, fold the material 30 in a desired manner, and provide the folded material 30 to an output end for sewing into a reinforcement strip 50. The body 60 changes shape as it extends downstream to fold the material 30 as it moves through the body 60. In the example embodiment shown in FIGS. 2-5, the body 60 includes a center sleeve 162, and opposing side sleeves 164, 166 that change size and shape to fold the material as the material moves downstream to an output end of the body 60. The side sleeves 164, 166 may be angled, curved, or otherwise adapted to extend from the edges of the mouth toward an outlet at an output end 170 of the body 60.

As shown in FIGS. 2 and 4, upstream the body 60 may be adjacent to a down stream end of the mouth 90 with the center sleeve 162 of a size to receive a center portion 180 of the material 30 and the side sleeves 164, 166 adapted to receive the outer edges 132, 134 of the material 30 extending through the mouth 90. The body 60 may be shaped so that as the body extends downstream in the direction that the material is passed through the body 60, the side sleeves 164, 166 increase in size to accept more of the material 30 as the center sleeve 162 decreases in size to fold the material 30 along a desired fold line. For example, as shown in FIG. 4, the center sleeve 162 may be sized so that a majority of the width w of the material is within the center sleeve with a small amount of material in the side sleeve 164, 166. The particular fold and output material size may be arranged for the particular application. For example, the body 60 may be arranged to fold the material 30 in the middle with no margin of the material or to fold the material 30 to provide an overlap margin between the folded portions.

As also shown in FIGS. 2 and 4, an access opening 190 may be provided in the body 60. The access opening 190 may be provided in the upper base wall 102 of the center sleeve 190 to allow a user to view the material 30 extending through the body 60 and to access the material 30 if desired. For example, when the material 30 is first passed through the former 12, a user may assist movement of the material 30 by pushing the material 30 with a finger or scissors extending through the access opening 190. The access opening 190 also allows a user to determine whether the material 30 is improperly bunching and provides an access point by which to correct the bunching.

As shown in FIGS. 2, 5 and 6, as the body 60 extends downstream, the center sleeve 162, and sidewalls 164, 166 converge at the output end 170. The body 60 is shaped so that less material 30 is in the center sleeve and more material 30 is within the sidewall sleeves 164, 166 as the material 30 moves downstream through the body 60 such that the material 30 is folded. For example, as shown in FIG. 6 the lower basewall 104 of the center sleeve 162 serves as a folding point about which the material 30 is folded.

In an example embodiment, the side sleeves 164, 166 include a major side sleeve 166 and a minor side sleeve 164. The major sleeve 166 and minor sleeve 164 may be of different sizes and shapes. For example, the major sleeve 166 may be of a larger size than the minor sleeve 164 so as to produce a folded arrangement in which the walls of the folded material are of different heights thereby creating a margin. In addition, the center sleeve 162 may be positioned off center from the center line of the material 30 fed into the former 12. Applicant has found that this arrangement helps prevent bunching of the material 30. Thus, as shown in FIG. 10, a length of material 30 will be folded along a fold line 200 that is off-center from a center line CL and result in a folded arrangement having major 204 and minor 206 folded portions that correspond to the major 164 and minor 166 sleeves through which the material is passed.

As shown in FIGS. 2 and 6, an output end 210 of the piping guide 84 may be positioned at the center sleeve 162. As shown in FIG. 6, the output end 210 of the piping guide 84 serves as a pocket former that pushes the material 30 outward as the material 30 moves along the outer diameter of the piping tube 150. As shown in FIG. 1 and FIG. 6, piping rope 32 may be inserted through the piping guide 84 for input into the fold within the material 30 by the piping tube 84.

The body 60 has an output end 170 through which the folded arrangement 40 is output. As seen in FIG. 2, an output guide 220 may be provided to assist in guiding the folded arrangement 40 to the sewing machine bed 18 for sewing with a needle 22.

As also shown in FIG. 2, a support strip guide 86 may be provided to guide a support strip 88 into the folded arrangement 40 (FIG. 11). In the example embodiment shown in FIGS. 2 and 11, the support strip guide 88 comprises a wire 230 extending from the mouth end of the body 60 that, with the edge of the mouth, forms an open-ended enclosure for receiving a support strip 88. In an example embodiment, a support strip 88 may be a trip of canvas material, but other materials may be used. In an example embodiment, a support strip 88 may be inserted through the support strip guide 86 and fed into the mouth 90 atop the material 30. As the support strip 88 and material 30 are passed through the guide 86 the support strip 88 is adjacent the material 30 so that the support strip 88 fits within the pocket created by the pocket former 80. In an example embodiment, the support strip 88 may be of a size such that it extends beyond the outer edges of the folded material pocket into which the support strip 88 is inserted so as to be visible. This provides an aesthetically pleasing look as an edge of the support strip 88 is visible.

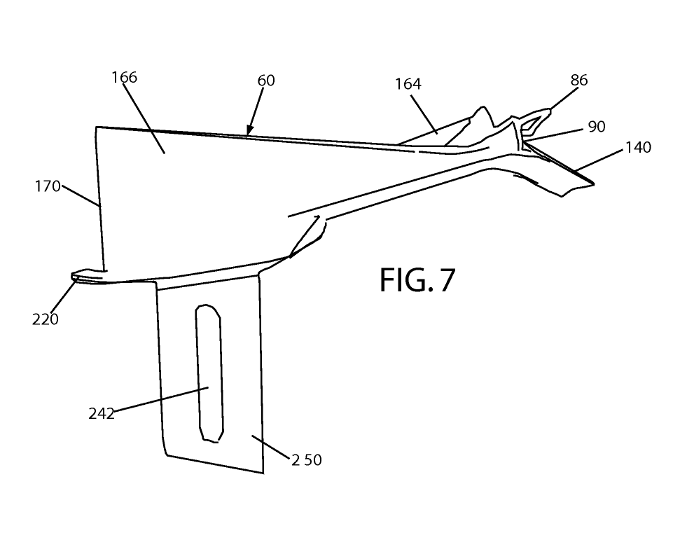

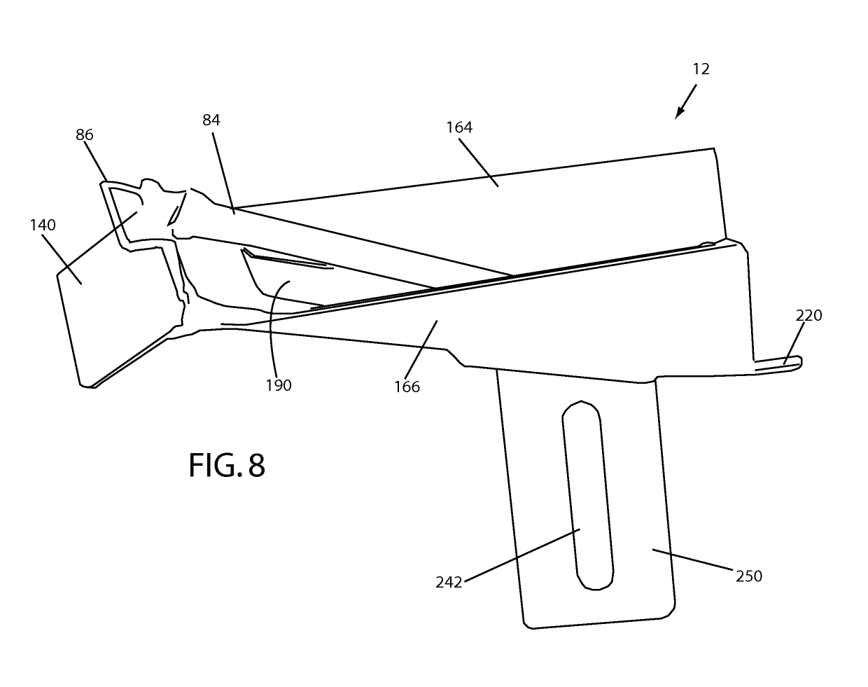

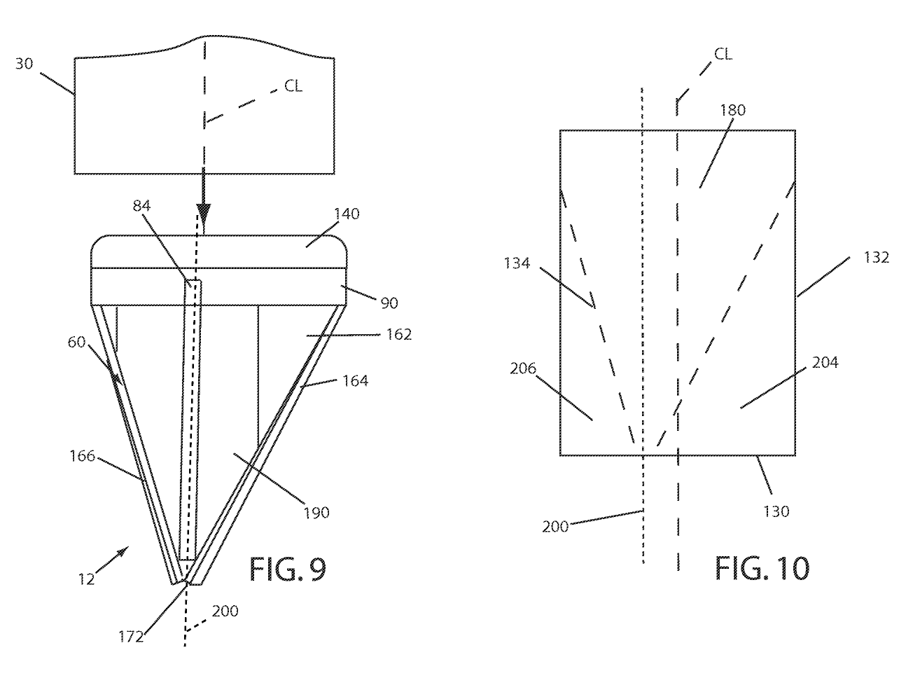

As shown in FIGS. 7 and 8, an attachment means may be provided for removably attaching the former 12 to a sewing machine 14. In the example embodiment shown in FIGS. 7-8, the attachment means is in the form of an attachment plate 240 having a slot 242 for receiving fasteners to attach the attachment plate to a sewing machine. For example, bolts (not shown) may be passed through the slot 242 and wingnuts (not shown) used to removably attach the attachment plate 240 to the bed 18 of the sewing machine 14 (FIG. 11). In another example embodiment a compressible attachment plate 250 may be used. The compressible attachment plate 250 may be inserted between a sewing machine bed 18 and its frame 260 to hold the former 12 in place. For example, in a conventional sewing machine 14, the bed 18 may be rotated out of its sewing position to reveal on opening 270 and the compressible plate 250 placed in the opening 270 adjacent a sidewall 180 of the frame 260. The bed 18 may then be rotated back into the opening 270 to compress the compressible plate 250 between the bed 18 and the frame 260. The compressible plate 250 may be made of a deformable material having sufficient resilience so that it moves from an initial condition to a compressed condition. The resilience of the compressible plate 250 pushing against the bed 18 and the frame 260 holds the compressible plate 250 in place.

In the example embodiment shown in FIG. 2, the outer sidewall 290 of the major sleeve 164 is generally planar so as to lie flat against the bed 18 of the sewing machine 14 to which the former 12 is attached. In that case, the attachment plate 240 may extend generally parallel to the sewing bed 18 to allow for easy attachment. In the example embodiment in which the compressible attachment plate 250 is used, the compressible attachment plate 250 extends so that when the former 12 in placed in position, the compressible plate extends downward for fitting between the sewing bed 18 and the frame 260.

In an example embodiment shown in FIG. 11, a feeder 300 may also be provided. The feeder 300 may fold a length of material 30 and provide the folded material 30 to the former 12 for further processing. In the example embodiment shown in FIG. 11, the feeder 300 includes a base 302 and two opposing side walls 314, 316. The feeder 300 may have an output end 320 that is removably engageable with the former 12. The feeder 300 may receive an unfolded length of material 30, fold the material 30 and provide the folded material 30 to the former 12 which again folds the material 30 as discussed above to form a double-folded arrangement. Thus, the feeder 300 may fold a length of material 30 having a width W1 along a first longitudinal fold line L1 to form a folded arrangement having a width W2 and the fabric former 12 folds the folded material again along a second fold line L2 to produce a double-folded material having a width W3.

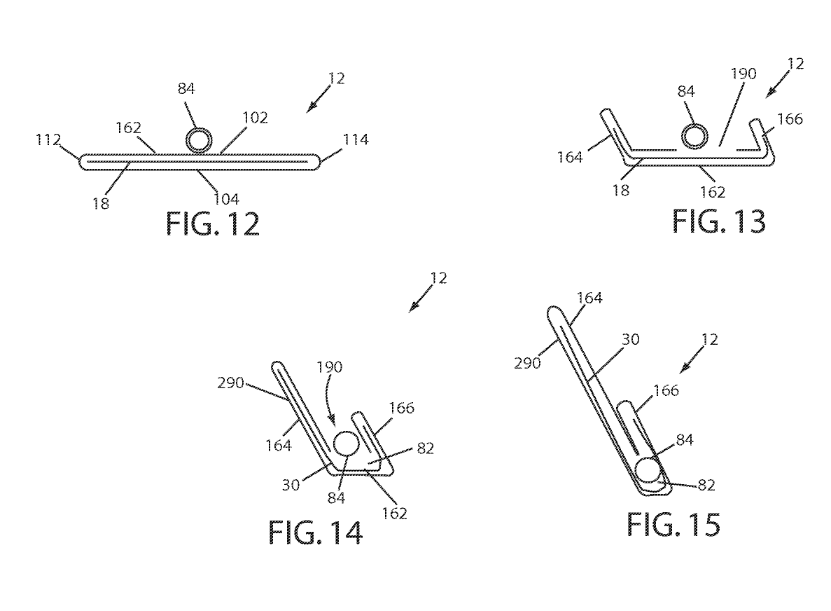

FIGS. 12-14 show the cross section views of FIGS. 3-6 in which a folded material 30 is provided to the former 12 by the feeder 300 and the material 30 is arranged into a folded arrangement 50.

In an example method, the work piece material 30 has a width of about 7 inches is urged into the feeder 300. The feeder 300 may have a base wall 330 that forms an arc having a circumference of about 7 inches. The leading edge 130 of the material 30 is inserted into the mouth 90 of the former 12. As discussed above, the bottom portion of the feeder 300 may have a crease that divides the feeder 300 into first and second sidewalls 314,316 which produce first 340 and second 342 walls of the material 30. As the material 30 passes through the folder 12 the base 330 curves to fold the material 30 and output a folded material having a first portion of about 3¾ and a second portion of about 3¼ to produce a margin of about ½. The resulting folded material from the feeder 300 may then be fed into the former 12 where it may again be folded and provided with a piping rope 32 and a support 88 to form a folded arrangement 40. The end result provides four layers of material 30 forming a reinforcement strip 50 arrangement a four-layer seam with piping and a support strip within the pocket.

While the invention has been disclosed in its preferred forms, it will be apparent to those skilled in the art that many modifications, additions, and deletions can be made therein without departing from the spirit and scope of the invention and its equivalents, as set forth in the following claims.

What is claimed is:

1. An apparatus, comprising:
a former configured to receive and fold a length of foldable material about a longitudinal fold line to form a folded material; and
a pocket maker adapted to create a pocket in the folded material.

2. The apparatus of claim 1, further comprising:
a piping guide configured to guide piping within the pocket.

3. The apparatus of claim 2, further comprising:
a support strip guide configured to receive a support strip and provide it to the pocket.

4. The apparatus of claim 3, further comprising:
a feeder configured to fold the foldable material and provide the folded foldable material to the former.

5. The apparatus of claim 1, wherein the former comprises a body having
a sleeve configured to receive and fold the foldable material.

6. The apparatus of claim 1, wherein the fold line is off center of the foldable material.

7. The apparatus of claim 1, wherein the former comprises a fold portion comprising a center sleeve and opposing side sleeves.

8. The apparatus of claim 1 wherein the former is shaped so that a body of the former extends downstream and side sleeves of the body increase in size as the center sleeve decreases in size.

9. The apparatus of claim 1 further comprising s sleeve for receiving the foldable material and providing the foldable material to a mouth of the former.

10. The apparatus of claim 1 further comprising an access opening in the former to allow access to the foldable material within the former.

11. The apparatus of claim 1, further comprising an attachment plate configured to removably couple the apparatus to a sewing machine.

12. The apparatus of claim 11, wherein said attachment plate is a compressible plate.

13. A method of forming a reinforcement strip, comprising:
inserting a length of foldable material through a former to fold the foldable material about a longitudinal fold line to form a folded material; and
moving the foldable material past a pocket maker to create a pocket in the folded material.

14. The method of claim 13, further comprising:
inserting piping through a piping guide to insert the piping at least partly into the pocket.

15. The method of claim 14, further comprising:
inserting a support strip through a support guide to provide the support strop to the pocket.

16. The method of claim 13, further comprising:
prior to inserting the foldable material through the former, inserting the foldable material through a feeder to fold the foldable material about a second fold line.

17. The method of claim 13, further comprising sewing the folded material into a reinforcement strip.

18. The method of claim 16, further comprising sewing the folded material into a reinforcement strip.

19. An apparatus, comprising:
a former configured to receive and fold a length of foldable material about a longitudinal fold line to form a folded material;
a pocket maker adapted to create a pocket in the folded material;
a piping guide configured to guide piping within the pocket; and
a support strip guide configured to receive a support strip and provide it to the pocket.

20. The apparatus of claim 19, further comprising:
an attachment plate configured to removably couple the former to a sewing machine.
